(19) United States
(12) Patent Application Publication
(10) Pub. No.: US 2009/0023543 A1
(43) Pub. Date: Jan. 22, 2009

(54) Gear Mechanism, In Particular Linkage Mechanism

(75) Inventors: Andreas Hoch, Talheim (DE); Matthias Haag, Stuttgart (DE); Stefan Kerpe, Renningen (DE)

Correspondence Address: CENTRAL COAST PATENT AGENCY, INC, 3 HANGAR WAY SUITE D, WATSONVILLE, CA, 95076, US

(73) Assignee: Schunk GmbH & KG Spann- und Greiftechnik, Bahnhofs, Lauffen am Neckar (DE)

(21) Appl. No.: 12/065,211

(22) PCT Filed: Aug. 8, 2006
(86) PCT No.: PCT/EP2006/007819

§ 371 Date: May 2, 2008

(30) Foreign Application Priority Data
Sep. 2, 2005 (DE) 102005042716.2

(51) Int. Cl. F16H 1/28; F16H 57/08

(52) U.S. Cl. 475/336

(57) ABSTRACT

The invention relates to a gear mechanism (40), in particular a linkage mechanism, having a base unit (42) and a rotational unit (44) which is mounted such that it can be rotated relative to the base unit about an articulation axis (46; 18), wherein the base unit has a drive element (48; 10) which can be driven rotationally, in particular, perpendicularly with respect to the articulation axis, having two rotationally mounted rotary members (54, 56; 14, 16) which can be driven in opposite directions by the drive element and are arranged, in particular, coaxially with respect to one another, wherein each of the rotary members drives a coupling element (60, 62; 30, 32) which is operatively connected to it when the drive element is rotating, wherein the two coupling elements are arranged such that they are mounted rotatably in a cage (68) of the rotational unit and are operatively connected to one another in such a way that, and wherein the drive body is operatively connected to the rotary members, the rotary members are operatively connected to the respective coupling element and/or the two coupling elements are operatively connected to one another in such a way that the cage is rotated about the articulation axis together with the rotational unit when the coupling elements are driven.

The invention relates to a gearbox, in particular a linkage gear for a handling device with a base unit and with a rotating unit that is supported around a linkage axis relative to the base unit. Such linkage drives are used, for example, in the fields of automation or robotics, for example to reliably implement positioning or grasping movements of handling devices.

Known from DE 32 30 648 C2 is an angular reversing gear with two succeeding planetary sets, where two crown wheels arranged along an axis are driven in opposite directions by a drive shaft.

Known from GB 442 462 is a planetary gearbox, where two bevel gear wheels arranged along an axis are driven in opposite directions by a drive shaft. The bevel gear wheels exhibit pinions that mesh with spur wheels. The spur wheels themselves are coupled in a movable fashion via bevel pinions.

Known from GB 922 005 is a reduction gear, where two crown wheels arranged along an axis are driven in opposite directions by an input shaft. The two crown wheels are coupled in a moveable fashion via sun wheels located opposite each other. It is the objective of the present invention to provide gear boxes that have a compact design, realize high gear ratios and exhibit a high power density.

This objective is achieved by a gearbox with the features of claim 1. With such an arrangement, a gear unit with a very compact design can be realized that exhibits a high reducing ratio and that can transmit great forces. According to the invention, the mentioned advantages can be realized in a small design space by splitting the rotational movement of the drive element onto the two rotating members and through the functional connection of the two coupling elements with each other.

It is advantageous if the drive element is arranged perpendicular to the linkage axis such that a drive shaft of a motor that can be coupled with the drive element can be arranged perpendicular to the linkage axis as well and coaxial or axis-parallel to the rotational axis of the drive element.

To achieve a high reducing ratio of the gearbox, the functional connections of the individual gear components can be realized according to the three independent and freely combinable approaches:
a) Providing differing reducing or gear ratios between the drive element and the two rotating members,
b) Providing differing reducing or gear ratios between the rotating members and the respective associated coupling elements, and
c) Providing a reducing or gear ratio other than 1 for the two coupling elements with each other.

Depending on the expectation profile on the gearbox, the approaches mentioned under a), b) and c) can be realized individually or in combination in order to achieve a rotational movement of the rotating member around a rotational axis.

In particular, a slightly different gear ratio or reducing ratio of the rotational movements of the coupling elements may be provided, which in the end will lead to the turning of the rotational unit versus a turning of the base unit.

According to a development of the invention, it is provided that the two rotating members are designed as gear rings, whereby the coupling elements are each arranged in a rotational coupling fashion at the inner circumference of one gear ring with the respective gear ring. The coupling elements are arranged such that they are able to rotate around their own longitudinal axis, which runs axis-parallel to the linkage axis, as well as around the linkage axis. When the drive element turns, the coupling elements run—rotating around their own longitudinal axis—along the inner circumferences of the gear rings in the fashion of planets. Through this design, the gearbox can be realized in a very compact manner because coupling elements running in the gear rings utilize the design space that is radially on the inside of the gear rings.

In particular it can be provided that the inner diameters of the two gear rings are at least slightly different. This can result in a turning of the rotating unit in relation to the base unit.

An additional advantageous design of the invention provides that the coupling elements are designed as shaft sections that extend at least in part through the two gear rings and that are rotationally mounted at the cage with their free ends. This achieves an advantageous and space-saving support for the coupling elements. The coupling elements can each exhibit a first coupling area in functional connection with its assigned gear ring and a second coupling area in functional connection with the respective other coupling element. The two coupling areas of the coupling elements can be identical or different. With identically designed coupling areas, it is conceivable that the two coupling areas merge into each other, leading to a simplified and therefore more cost-effective manufacture of the coupling elements.

According to another embodiment of the invention, it can be provided that the two rotating members exhibit outer wheel sections that interact through their outer circumferences with the coupling elements. This embodiment has the advantage over the embodiment with the gear rings that the rotating members can be supported in the area of their rotational axis. The respective coupling elements run along the outer circumferences. The outer diameters of the two outer wheel sections can be different.

According to the invention, it may also be advantageous if the cage is rotationally mounted to the base unit for turning the rotating unit. Since the cage is turned, the entire rotating unit can be turned via the cage through an appropriate support of the cage at the base unit.

In case relatively high forces are to be transmitted via the gearbox, the drive element can be located as a bevel pinion between the two rotating members, which are then designed as bevel gear wheels that mesh with the bevel pinion. According to the invention, other rotating couplings can be provided as well. For example, the drive element can be designed as a friction wheel between the two rotating members, which are then designed as friction discs driven by the friction wheel. The friction wheel can then be located in a plane perpendicular or slanted toward the rotating axis of the rotating discs, for example.

Another embodiment of the invention stands out in that the two rotating members are rotationally coupled with the coupling elements and/or the two coupling elements with each other through teeth or friction surfaces. Providing a tooth connection suggests itself in particular in instances, when relatively high forces are to be transmitted.

In those cases where the movement of individual rotating components are coupled and move together via geared teeth, gears with different numbers of teeth can be used. For example, it is conceivable that in embodiments where the rotating members are designed as gear rings, the inner circumference of the one gear wheel exhibits one more or one less tooth than the inner circumference of the other gear ring.

To support the rotating members that are driven by the drive element, it conceivable according to the invention that at least one support element is provided that is coupled in its movement with the drive element and is located at the base unit. The support element is, in particular, rotationally mounted and follows the rotational movement of the rotating members. The support elements can, in particular, be designed identical to the drive element, whereby the support element does not need to be driven by an additional component but follows exclusively the rotational movement of the rotating members. Advantageously, several support elements are provided over the circumference of the rotating members, in particular at equal distances to each other. In this manner, it is possible to transmit in particular great forces between the base unit and the rotating unit.

One advantageous and compact design of the gearbox arises, when the coupling elements are arranged axis-parallel to each other and/or axis-parallel to the linkage axis. In addition, it is advantageous, when the rotating unit and/or the cage exhibits a coupling section that is arranged radially and/or axially to the linkage axis for arranging additional components. Additional components may be, for example, spacer elements and/or grasping elements and/or additional gearboxes and/or drive units.

Additional advantages and advantageous embodiments of the invention become apparent from the following description wherein the invention is described and explained in greater detail based on the drawing, of which:

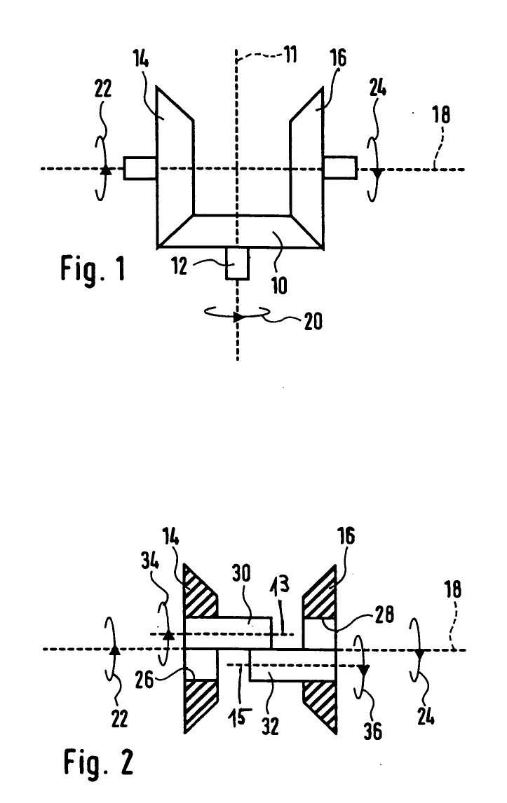

FIG. 1 is a schematic presentation of a drive element with two rotating members rotationally coupled to the drive element as part of a linkage gear subject to the invention;

FIG. 2 shows two rotating members rotationally coupled to a coupling element as part of a linkage gear subject to the invention;

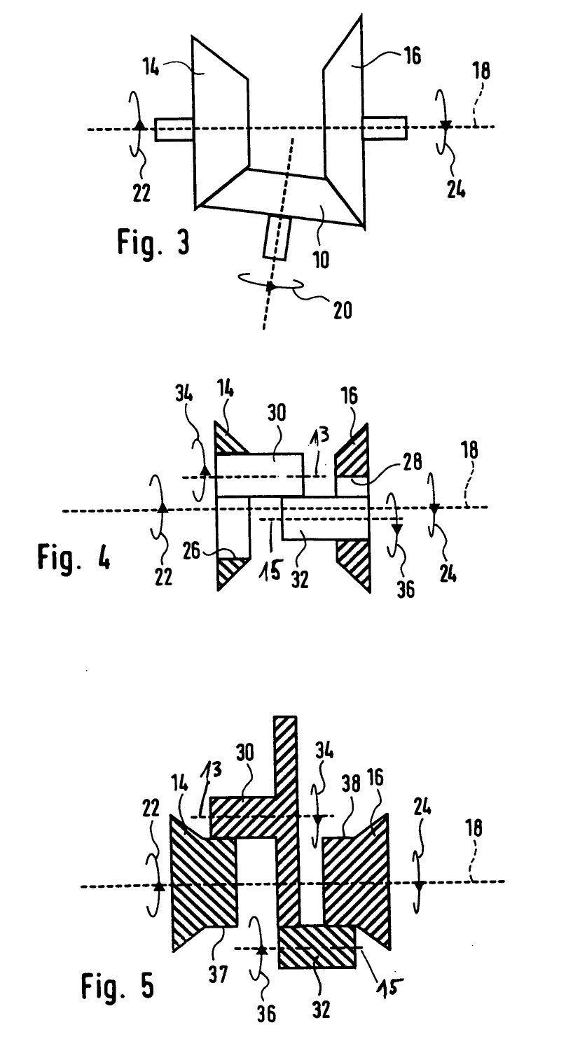

FIG. 3 is a schematic presentation according to FIG. 1 with rotating members of different diameters;

FIG. 4 is a schematic presentation corresponding to FIG. 2 exhibiting rotating members with different inner diameters;

FIG. 5 is an additional embodiment of rotating members with different coupling elements according to a linkage gear subject to the invention;

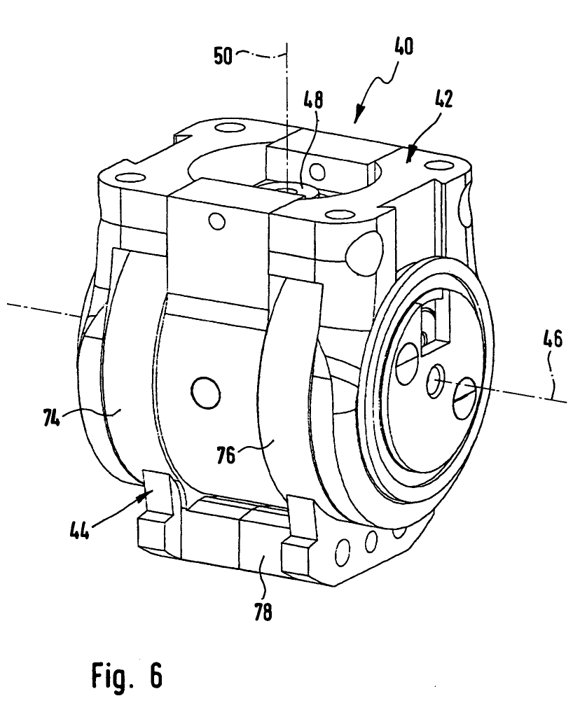

FIG. 6 is a perspective external view of an additional embodiment of a linkage gear subject to the invention;

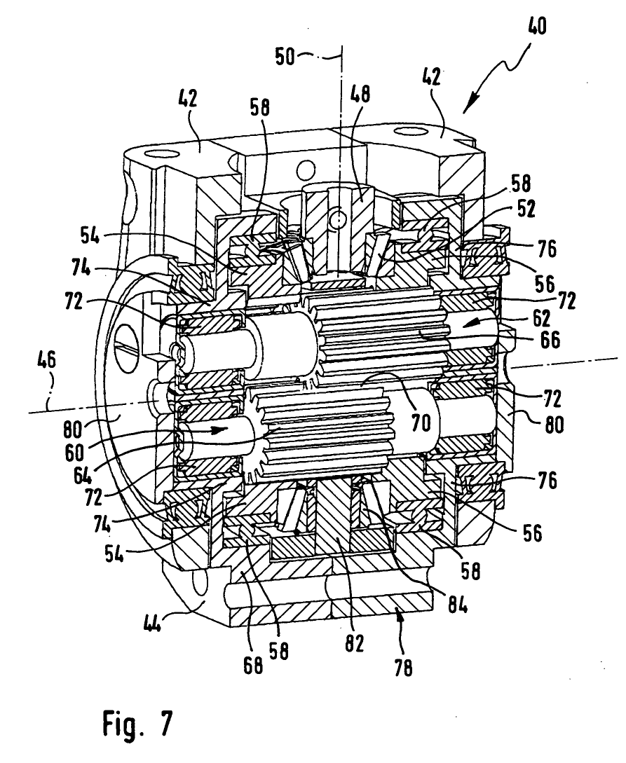

FIG. 7 shows a longitudinal section through the linkage gear according to FIG. 6; and

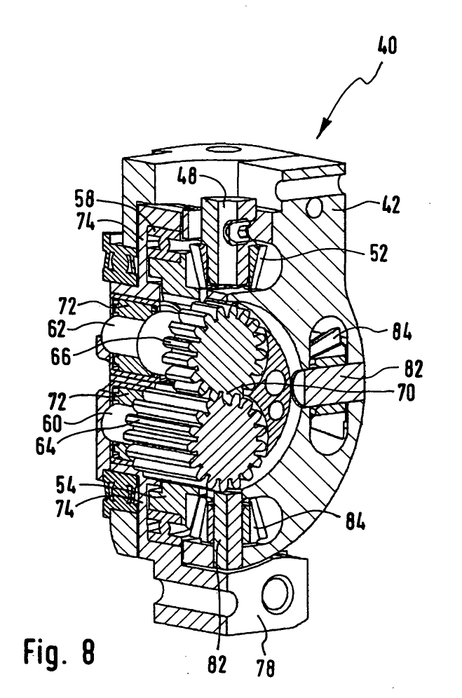

FIG. 8 shows is a cross-section through the longitudinal section according to FIG. 7.

FIGS. 1 to 5 schematically show different components of linkage gears subject to the invention.

FIG. 1 shows a drive element 10 that can be driven by a motor and that has a shaft extension 12, which is rotationally coupled with a shaft that can be driven by a motor, in particular an electric motor. The drive element 10 is designed as a bevel wheel, exhibiting beveled toothing or a friction surface for rotational coupling with two rotating members 14, 16 that are arranged coaxially to each other. The rotational axis 18 of the two rotating members 14, 16 is arranged orthogonal to the rotating axis 11 of the drive element 10. The rotating members 14, 16 also have a bevel wheel type design with toothings or frictional surfaces running at an angle to the rotating axis 18.

When turning the drive element 10 in the rotating direction indicated by the arrow 20, the two rotating members 14, 16 turn in different directions indicated by the arrows 22, 24.

In FIG. 2, where the drive element 10 is not shown, the two rotating members 14, 16 are designed as gear rings. A coupling element 30, 32 is rotationally mounted around its respective longitudinal axis 13, 15 in a rotationally coupled manner at the inner circumference 26 of the gear ring 14 and at the inner circumference 28 of the other gear ring 16. The two coupling elements 30, 32 may have a functional connection to the respective inner circumference via, for example, toothing or a friction surface.

A rotational movement of the rotating member 14 or 16, respectively, around the rotating axis 18 affects a rotational movement of the coupling element 30 or 32, respectively, around its respective longitudinal axis 13 or 15, respectively.

As is furthermore apparent from FIG. 2 that the two coupling elements 30, 32 have a functional connection with each other. They can be rotationally coupled with each other via friction surfaces or toothings.

When turning the rotating member 14 in the rotational direction 22, the coupling element 30 rotates around its longitudinal axis 13 in the rotational direction indicated by the arrow 34 with the rotating member 14 via the rotating coupling of the coupling element 30. Correspondingly, when turning the rotating member 16, the coupling element 32 is turned around its longitudinal axis 15 in the rotational direction 36. According to the invention, it is provided that the design is such that the longitudinal axes 13, 15 of the two coupling elements 30, 32, which are both rotationally mounted on a cage not shown in FIGS. 1 to 5, change their relative position in relation to the rotational axis 18 when the rotating members 14, 16 are turned.

FIG. 3 shows an embodiment, where the gear ratios from the drive element 10 to the two rotating members 14, 16 differ from each other. This results in a different rotational speed of the counter-rotating rotating members 14, 16 when the drive element 10 is turned. In a design that otherwise corresponds to that of FIG. 2, the coupling elements 30, 32 move in the manner of planets, which each rotates around its own longitudinal axis 13, 15, and additionally around the axis 18. The already mentioned, in FIGS. 1 to 5 not shown, cage, which takes up the coupling elements 30, 32, experiences a rotation around the rotational axis 18 as well. In this manner, the rotational axis also constitutes the linkage axis, where the cage is a part of the rotating unit, which is then turned around the linkage axis 18.

To achieve different rotational speeds of the rotating members 14 and 16 it is not necessary that the rotational axis of the drive element 10 has to run at an angle that is 90° different to the rotational axis 18 as shown in FIG. 3. According to the invention, different rotational speeds can be achieved also with an orthogonal arrangement, for example by providing toothings at the drive element 10 and the rotating members 14, 16, whereby in this case the toothing of the rotating member 14 is designed different from the toothing of the rotating member 16.

In FIG. 4, a relative movement of the longitudinal axes 13, 15 of the two coupling elements 30, 32 around the rotational axis 18 is achieved through a different gear ratio of the coupling elements 30, 32 versus the respective rotating members 14, 16 assigned to them. When providing gear rings, as shown in FIGS. 2 and 4, this can be achieved through different inner diameters 26, 28 of the two gear rings 14, 16. In FIG. 4, the inner diameter 26 of the gear ring 14 is greater than the inner diameter 28 of the gear ring 16. If for the rotational coupling toothings are provided at the inner diameters 26, 28 and correspondingly counter-toothings at the coupling elements that mesh with the toothings of the rotating members 14, 16, then the relative movement of the two coupling elements 30, 32 around the rotational axis 18 can be realized through at least slightly different toothings. In this case, it is conceivable that the toothings on the side of the coupling elements are identical and that toothings with different numbers of teeth are provided at each of the inner diameters 26, 28.

FIG. 5 shows an additional conceivable arrangement subject to the invention. For one, the two rotating members 14, 16 in FIG. 5 each provide outer wheel sections 37, 38 that are rotationally coupled with the coupling elements 30, 32. For another, the functional connection of the two coupling elements 30, 32 is designed such that the related gear ratio does not equal one. For turning rotating members 14, 16, the result is a relative movement of the rotational axes 13, 15 of the coupling elements 30, 32 around the axis 18. The drive element 10 is not shown in FIGS. 4 and 5 for purposes of a simplified presentation.

The linkage gear subject to the invention presented in FIGS. 6 to 8 comprises a base unit 42 and a rotating unit 44 that is rotationally mounted around a linkage axis 46. The base unit 42 comprises a drive element 48 with a rotational axis designated with the character 50 and which is rotationally mounted perpendicular to the linkage axis 46 and can be driven via a motor shaft. To drive the drive element 48, a drive unit may be attached to the base unit, for example.

As is apparent, in particular in the sections of FIGS. 7 and 8, the drive element 48 exhibits a bevel wheel pinion 52 that drives two rotationally mounted rotating members 54, 56 arranged coaxially along the linkage axis 46, in opposite rotational directions. The two rotating members 54, 56 are designed as bevel gear wheels with toothing pointing at each other which mesh with the toothing of the drive element 48. Furthermore, the rotating members 54, 56 are designed as gear rings that are rotationally mounted at their axial outer circumference via respective support elements 58.

Furthermore, the linkage drive 40 provides two coupling elements 60, 62, whereby the coupling element 60 has a functional connection with the inner circumference of the rotating member 54 in such a manner that the coupling element is driven around its own axis when the rotating member 54 turns. In a corresponding manner, the coupling element 62 is rotationally coupled with the inner circumference of the rotating member 56. For the rotational coupling between the rotating members 54, 56 and the coupling elements 60, 62, the rotating members 54, 56 exhibit at their inner circumferences toothings that mesh with the toothings 64, 66 that are present at the outer circumferences of the coupling elements 60, 62. The coupling elements 60, 62 have a shaft-like design and are supported at their free ends at a cage 68 in a manner that allows them to rotate around their own longitudinal axis. In the center area of the coupling elements 60, 62, the two coupling elements 60, 62 are rotationally coupled via a common toothing area 70. As is apparent, especially from FIG. 7, the toothing area of the toothing 64 of the coupling element 60, which is in functional contact with the rotating member 54, transitions into the area 70 of toothing 64, which is in functional contact with the other coupling element 62. Correspondingly, the toothing area of the toothing 66 of the coupling element 62, which is in functional contact with the rotating element 56, transitions into the toothing area 70, which meshes with the toothing 64 of the other coupling element 60.

The cage 68 with its overall U-shape exhibits at its parallel running members 74 and 76 support elements 72 for rotational support of the free ends of the coupling elements 60 and 62. At its area that connects the two members 74 and 76, the cage 68 exhibits a coupling section 78 for the arrangement of additional components. The cage 68 is covered with two housing elements 80 at its outer lying area, when viewed in the direction of the linkage axis 46. According to the invention, it is also conceivable that coupling sections are also provided at the housing elements 80 in order to arrange additional components.

If the drive element 48 is driven by a motor, the two rotating members 54, 56 turn at the same speed in the opposite rotational direction. In this case, the two rotating members exhibit identical outer bevel toothing pointing toward each other. Advantageously, the inner toothings of the two rotating members 54, 56 differ by one tooth only. This as well as the common rotational coupling of the coupling elements 60, 62, affect a relative movement of the longitudinal axes of the coupling elements 60, 62 around the linkage axis 46. Due to the support of the coupling elements 60, 62 at the cage, the cage moves around the linkage axis 46 when the drive element 48 turns. In the end, the rotating unit 44, which comprises, in particular, the cage 68, the members 74, 76 as well as the two housing elements 80, makes a rotating movement around the axis 46 in relation to the base component 42.

For better support of the two rotating members 54, 56 it is provided that a total of four support elements 82 are provided at the base unit 42. The support elements 82 comprise rotatably supported bevel gear wheels 84 that correspond to the bevel wheel pinion 52, where the toothings of the rotating members 54, 56 run.

Instead of providing toothing as explained based on FIGS. 6 to 8, corresponding friction elements and friction surfaces, respectively, may be provided.

Due to the design of the linkage gear 40 explained above, a linkage gear can be provided that can be driven via a drive element 48, which can be driven perpendicular to the linkage axis 46, which has a very compact design, exhibits a very high reducing ratio and that is capable of transmitting very high forces.

1. A gearbox (40), in particular a linkage gear for a handling device, comprising a base unit (42) and a rotating unit (44) that is rotationally supported against the base unit around a linkage axis (46; 18), whereby the base unit (42) exhibits a rotationally drivable drive element (48; 10),
with two rotationally supported rotating members (54, 56; 14, 16) that can be driven in opposite directions by the drive element (48; 10), whereby each of the rotating members (54, 56; 14, 16) drives a coupling element (60, 62; 30, 32) when the drive element (48; 10) turns,
whereby the two coupling elements (60, 62; 30, 32) are arranged in a cage (68) of the rotating unit (44) axis-parallel to each other around their respective longitudinal axis (13, 15), rotationally supported and directly rotationally coupled with each other and
whereby the drive element (48; 10) is functionally coupled with the rotating members (54, 56; 14, 16), the rotating members (54, 56; 14, 16) with the respective coupling element (60, 62; 30, 32) and the two coupling elements (60, 62; 30, 32) with each other such that the cage (68) together with the rotating unit (44) rotates around the linkage axis (46; 18) when the coupling elements (60, 62; 30, 32) are driven.

2. A gearbox (40) as set forth in claim 1, characterized in that the rotating members (54, 56; 14, 16) are driven by the drive element (48; 10) and/or the two coupling elements (60, 62; 30, 32) by the respective rotating member (54, 56; 14, 16) with different reducing or gear ratios, and/or that the gear ratio of the two coupling elements (60, 62; 30, 32) in relation to each other does not equal one.

3. A gearbox (40) as set forth in claim 2, characterized in that the two rotating members (54, 56; 14, 16) are designed as gear rings, whereby the coupling elements (60, 62; 30, 32) are each rotationally coupled with the respective gear ring at the inner circumference of the gear ring.

4. A gearbox (40) as set forth in claim 3, characterized in that the inner diameters and/or the toothings provided at the inner diameters of the two gear rings (54, 56; 14, 16) are different from each other.

5. A gearbox (40) as set forth in claim 4, characterized in that the coupling elements (60, 62; 30, 32) are designed as shaft sections that at least in sections extend through the two gear rings (54, 56; 14, 16) and are each at their free ends rotationally supported at the age (68) around their respective longitudinal axis.

6. A gearbox (40) as set forth in claim 5, characterized in that the coupling elements (60, 62; 30, 32) respectively exhibit a first coupling area that is functionally coupled to the gear ring (54, 56; 14, 16) that is assigned to it and a second coupling area (70) that is functionally coupled to the respective other coupling element.

7. A gearbox (40) as set forth in claim 6, characterized in that the two coupling areas of a coupling element (60, 62) transition into one another.

8. A gearbox (40) as set forth in claim 2, characterized in that the two rotating members (14, 16) exhibit outer wheel sections (37, 38) whose outer circumferences interact with the coupling elements (30, 32).

9. A gearbox (40) as set forth in claim 8, characterized in that the outer diameters and/or the outer wheel toothings at the outer diameters of the two outer wheel sections are different from each other.

10. A gearbox (40) as set forth in claim 9, characterized in that the cage (68) is rotationally supported for the purpose of turning the rotating unit at the base unit and/or at the rotating members (54, 56).

11. A gearbox (40) as set forth in claim 10, characterized in that the drive element (48; 10) is arranged as a bevel pinion between the two rotating members, which are designed as bevel gear wheels that mesh with the bevel pinion.

12. A gearbox (40) as set forth in claim 11, characterized in that the drive element is arranged as a friction wheel between the two rotating members, which are designed as friction discs driven by the friction wheel.

13. A gearbox (40) as set forth in claim 12, characterized in that the two rotating members (54, 56; 30, 32) are rotationally coupled with the coupling elements (60, 62; 30, 32) and/or the two coupling elements are rotationally coupled with each other via toothings or friction surfaces.

14. A gearbox (40) as set forth in claim 13, characterized in that at the base unit (42) at least one support element (82) is movably coupled with the rotating members (54, 56; 14, 16) for supporting the rotating members.

15. A gearbox (40) as set forth in claim 14, characterized in that the two coupling elements are arranged axis-parallel to the linkage axis (46; 18).

16. A gearbox (40) as set forth in claim 15, characterized in that the rotating unit (44) and/or the cage (68) exhibits a coupling section (78) that is arranged radially and/or axially to the linkage axis (46) for arranging additional components.
